(19) United States
(12) Patent Application Publication
(10) Pub. No.: US 2020/0322073 A1
(43) Pub. Date: Oct. 8, 2020

(54) CHANNEL CAPACITY PREDICTION METHOD AND APPARATUS, WIRELESS SIGNAL SENDING DEVICE AND TRANSMISSION SYSTEM

(71) Applicant: SZ DJI TECHNOLOGY CO., LTD., Shenzhen (CN)

(72) Inventors: Ying CHEN, Shenzhen (CN); Ning MA, Shenzhen (CN); Jin DAI, Shenzhen (CN)

(21) Appl. No.: 16/909,625

(22) Filed: Jun. 23, 2020

Related U.S. Application Data
(63) Continuation of application No. PCT/CN2017/120218, filed on Dec. 29, 2017.

(51) Int. Cl. H04B 17/391; H04L 12/26; H04B 17/26; H04L 12/24; H04B 17/373

(52) U.S. Cl. CPC H04B 17/3913; H04L 43/50; H04B 17/373; H04L 41/0896; H04L 43/0882; H04B 17/26

(57) ABSTRACT

A channel capacity prediction method includes collecting historic data of a channel for transmitting wireless signals to generate statistics information, obtaining a capacity prediction result based on the statistics information including calculating a predicted capacity, and outputting the capacity prediction result.

### CROSS-REFERENCE TO RELATED APPLICATION

This application is a continuation of International Application No. PCT/CN2017/120218, filed on Dec. 29, 2017, the entire content of which is incorporated herein by reference.

### TECHNICAL FIELD

The present disclosure relates to the technical field of wireless communication technology and, more particularly, to a channel capacity prediction method and apparatus, a wireless signal sending device, and a wireless transmission system.

### BACKGROUND

With the rapid development of wireless communication technology, applications of the wireless communication technology in long distance image transmission, such as video surveillance and first person view (FPV), are undergoing substantial growth.

In such wireless communication technology, it is essential to predict wireless channel capacity and control target bit error rate. These are difficult points that those skilled in the art are struggling with. Because condition of a wireless channel rapidly changes and wireless interferences constantly change, it is difficult to accurately predict wireless channel capacity and a bit rate of a wireless signal carried in the corresponding wireless channel. Inaccurate prediction is likely to cause a substantial deviation in target bit rate control, resulting frame loss, pausing, buffering, or link loss of the transmitted signal. For a wireless image transmission system that has stringent real-time requirements, troubles such as frame loss and pausing of a streaming video will substantially degrade user experience.

Thus, there is a need to resolve the technical problems including providing more accurate channel capacity prediction with smaller deviation, reducing occurrences of frame loss, pausing, and link loss while maintaining signal transmission quality at the same time, and improving user experience.

### SUMMARY

In accordance with the disclosure, there is provided a channel capacity prediction method including collecting historic data of a channel for transmitting wireless signals to generate statistics information, obtaining a capacity prediction result based on the statistics information including calculating a predicted capacity, and outputting the capacity prediction result.

Also in accordance with the disclosure, there is provided a channel capacity prediction apparatus including a processor and a memory storing computer executable instructions. When being executed by the processor, the instructions cause the processor to collect historic data of a channel for transmitting wireless signals to generate statistics information, obtain a capacity prediction result based on the statistics information including calculating a predicted capacity, and output the capacity prediction result.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of a wireless signal transmission system according to an embodiment of the present disclosure.

FIG. 2 is a schematic structural diagram of a signal processing device and a wireless signal sending device in the wireless signal transmission system according to an embodiment of the present disclosure.

FIG. 3 illustrates problems of an example channel capacity prediction method.

FIG. 4 is a flowchart of a channel capacity prediction method according to an example embodiment of the present disclosure.

FIG. 5A is a flowchart of a channel capacity prediction process according to an example embodiment of the present disclosure.

FIG. 5B is a flowchart of a predicted result output process according to an example embodiment of the present disclosure.

FIG. 6 is a flowchart of the channel capacity prediction process according to another example embodiment of the present disclosure.

FIG. 7 is a flowchart of the predicted result output process according to another example embodiment of the present disclosure.

FIG. 8 is a schematic structural diagram of a channel capacity prediction apparatus according to an embodiment of the present disclosure.

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

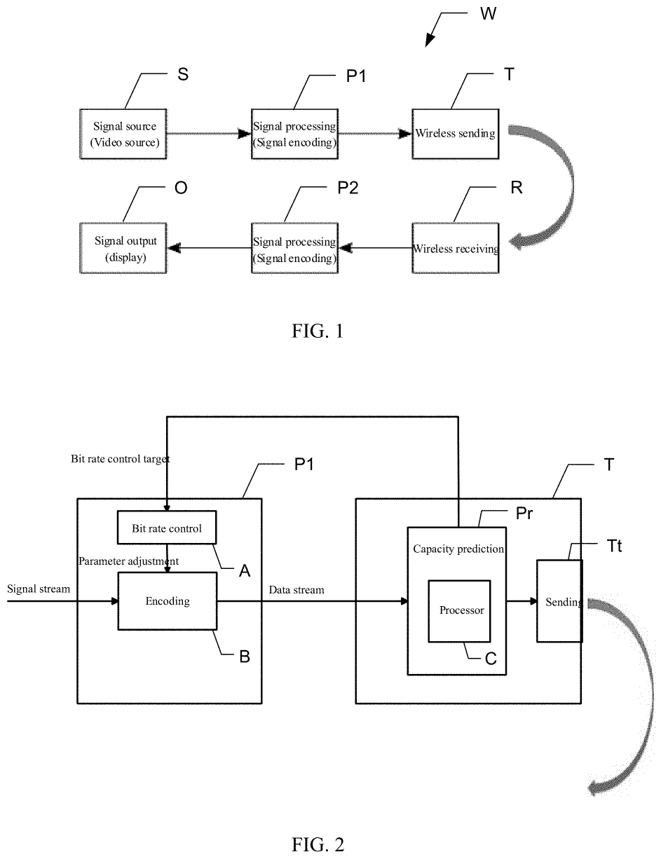

FIG. 1 is a schematic structural diagram of a wireless signal transmission system according to an embodiment of the present disclosure. As shown in FIG. 1, the wireless signal transmission system W includes at least a wireless signal transmitter and a wireless signal receiver. The wireless signal transmitter includes at least a signal source S, a signal processing device P1, and a wireless signal sending device T. Correspondingly, the wireless signal receiver includes a wireless signal receiving device R, a signal processing device P2, and a signal outputting device O.

In some embodiments, the wireless signal transmission system W show in FIG. 1 is an ordinary wireless image transmission system. At the transmitter side, the signal source S may be a video source, and the signal processing device P1 may be a signal encoding device for encoding signals. The signal processing device P1 also includes a bit rate control circuit for controlling the bit rate (bit stream rate). The bit rate control circuit will be described in detail below with reference to FIG. 2.

In addition, the wireless signal sending device T is configured to send signals after being processed (e.g., being encoded) by the signal processing device P1. The structure of the wireless signal sending device T will be described below with reference to FIG. 2. On the other hand, at the signal receiver side, the wireless signal receiving device R receives the signals sent by the wireless signal sending device T, the signal processing device P2 processes the signals, and the processed signals are outputted to the signal outputting device O (e.g., for being displayed).

In addition, the image transmission system shown in FIG. 1 is for illustrative purposes, and should not be limiting the present disclosure. It is obvious that the wireless signal transmission system W includes at least the signal source, the signal processing device, the wireless sending device, which can be configured as separate modules or one integrated module. The receiver side can be any type of structures.

Main structures including the wireless signal sending device T and the signal processing device P1 of the wireless signal transmission system W are described below with reference to FIG. 2.

FIG. 2 is a schematic structural diagram of a signal processing device and a wireless signal sending device in the wireless signal transmission system W according to an embodiment of the present disclosure.

As shown in FIG. 2, the signal processing device P1 includes at least a bit rate control circuit A for controlling the bit rate (data stream bit rate) and an encoding circuit B for signal processing (e.g., encoding). The encoding circuit B performs encoding processing on the signal stream from a signal source, and outputs the encoded data stream to the wireless signal sending device T. In this case, the encode data stream fluctuates as application complexity of the signal stream (e.g., video stream) of the signal source changes. The bit rate control circuit A suppresses the fluctuation. That is, the bit rate control circuit A is configured to maintain a stable bit rate (data stream bit rate) outputted from the encoding circuit B. The bit rate control circuit A receives a bit rate control target inputted externally, and based on the bit rate control target, adjusts an encoding parameter of the encoding circuit B. In this case, the bit rate control target should be as close to an actual channel capacity as possible, and the bit rate control circuit A controls the encoding circuit B to output the data stream at the bit rate as close to the bit rate control target as possible.

In addition, an input source for the bit rate control target can be configured by a user in advance or be determined based on a measurement feedback from the transmitter side. Here, the example shown in FIG. 2 is based on the measurement feedback from the transmitter side.

In addition, as shown in FIG. 2, the wireless signal sending device T includes at least a transmitter circuit Tt, a capacity prediction circuit Pr including a processor C. The transmitter circuit Tt includes at least a channel (also known as signal channel) and transmits the data streaming through the channel. The capacity prediction circuit Pr receives the data stream after being processed by the signal processing device P1 (e.g., being encoded by the encoding circuit B), and detects and records past (historic) statistical data of changes of the channel. The processor C performs the channel capacity prediction according to the statistical data, sets a prediction result as the bit rate control target, and feeds the bit rate control target to the bit rate control circuit A of the signal processing device P1. In addition, the statistical data includes at least historic throughput of the channel (also referred to as “historic channel throughput”). Moreover, the statistical data of the channel may include at least one of the historic throughput, a historic signal-to-noise ratio, a historic signal intensity, a historic modulation mode, or a historic channel estimation.

In some embodiments, a capacity prediction method performed by the processor C included in the capacity prediction circuit Pr may include a window averaging algorithm or a least squares fitting straight line algorithm as a linear filter.

For example, assuming that the historic throughputs of the channel corresponding to preceding N frames are C1, C2, . . . , CN, where N is a natural number greater than or equal to 1.

In the window averaging algorithm, the capacity prediction is performed by the following equation (1):

$${c}_{N + 1} = \frac{1}{N} {Σ}_{i = 1}^{N} {c}_{i} \qquad ( 1 )$$

where cᵢ represents a historic throughput of the channel corresponding to i-th preceding frame, i is a natural number greater than or equal to 1 and smaller than or equal to N, and c_{N+1} is the predicted capacity.

In the least squares fitting straight line algorithm, the capacity prediction is performed by the following equation (2):

c_{N+1}=â×(N+1)+\hat{b} (2)

where â and \hat{b} are obtained by the following equation (2-1) and equation (2-2),

$$\begin{matrix}\hat{a} = \frac{( {Σ}_{1}^{N} {i}^{2} ) ( {Σ}_{1}^{N} {c}_{i} ) - ( {Σ}_{1}^{N} i ) ( {Σ}_{1}^{N} i \times {c}_{i} )}{N ( {Σ}_{1}^{N} {i}^{2} ) - {( {Σ}_{1}^{N} i )}^{2}} & ( 2 \text{-} 1 ) \\ \hat{b} = \frac{N ( {Σ}_{1}^{N} i \times {c}_{i} ) - ( {Σ}_{1}^{N} i ) ( {Σ}_{1}^{N} {c}_{i} )}{N ( {Σ}_{1}^{N} {i}^{2} ) - {( {Σ}_{1}^{N} i )}^{2}} & ( 2 \text{-} 2 )\end{matrix}$$

similarly, cᵢ represents the historic throughput of the channel corresponding to the i-th preceding frame, i is a natural number greater than or equal to 1 and smaller than or equal to N, and c_{N+1} is the predicted capacity.

However, the window averaging algorithm and the least squares fitting straight line algorithm may have certain disadvantages, for example, a difference between the predicted channel capacity and the actual channel capacity may be large and it may be unable to track a trend of changes of the channel. As a result, the actual channel capacity may not be fully utilized, the encoding bit rate may be too low, and the video quality of the image transmission system may degrade. Further, the encoding bit rate may exceed the actual channel capacity, and pausing, frame loss, and link loss may occur.

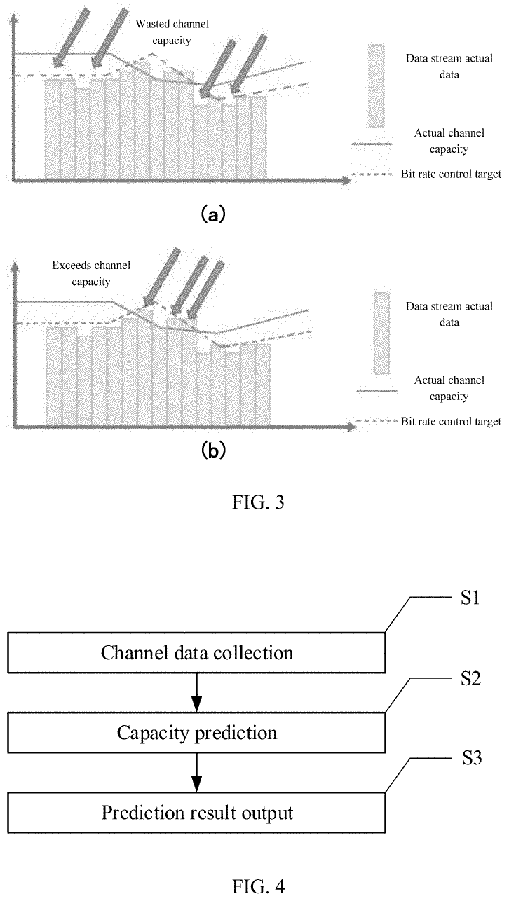

FIG. 3 illustrates problems of an example channel capacity prediction method. Part (a) of FIG. 3 shows a situation where channel capacity is wasted and part (b) of FIG. 3 shows a situation where channel capacity is exceeded. In FIG. 3, bars represent actual data of the data stream, the solid line represents time channel capacity, and the dash line represents the bit rate control target (i.e., the predicted capacity).

As shown in part (a) of FIG. 3, portions of the dash line representing the bit rate control target (i.e., the predicted capacity) are obviously lower than corresponding portions of the solid line representing the time channel capacity. That is, regarding those portions, the channel capacity is not fully utilized, resulting in a waste of the channel capacity.

As shown in part (b) of FIG. 3, a portion of the dash line representing the bit rate control target (i.e., the predicted capacity) is obviously higher than a corresponding portion of the solid line representing the time channel capacity. That is, regarding that portion, the encoding bit rate exceeds the actual capacity, and it is likely to cause issues such as pausing, frame loss, or even link loss.

To solve the technical problems in the existing technologies, the present disclosure provides a machine learning algorithm. That is, channel statistical data is used to train a model, and the trained model is used to predict a prediction value of the channel capacity in a succeeding frame.

Example channel capacity prediction method according to the present disclosure is described below in connection with FIGS. 1, 2, 4, 5A, and 5B. The channel capacity prediction method may be applied to the wireless signal transmission system W and the wireless signal sending device T, as described in the embodiments of the present disclosure.

FIG. 4 is a flowchart of a channel capacity prediction method according to an example embodiment of the present disclosure. As shown in FIG. 4, the channel capacity prediction method includes: collecting channel data (S1), predicting capacity (S2), and outputting prediction result (S3).

At the channel data collection process (S1), the wireless signal sending device T (specifically, the transmitter circuit Tt) may be used to collect historic data of the channel for sending the wireless signals and to generate statistics information. The historic data may include at least the historic throughput of the channel, and may, according to actual applications, include at least one of the historic throughput, the historic signal-to-noise ratio, the historic signal intensity, the historic modulation mode, or the historic signal estimation. For example, as previously described, the historic data may include the historic throughputs of the channel corresponding to the preceding N frames, and the generated statistics information may be represented by C₁, C₂, . . . , C_{N}, where C represents the historic throughputs of the channel corresponding to the respective preceding N frames, and N is a natural number greater than or equal to 1.

At the capacity prediction process (S2), the machine learning algorithm is used to calculate a first predicted capacity of the channel according to the statistics information. In this case, the machine learning algorithm may be any of the machine learning methods, such as decision tree, least square method, logistic regression, integrated learning, or cluster learning.

At the prediction result output process (S3), the first predicted capacity calculated at the capacity prediction process S2 is outputted as a capacity prediction result. That is, the first predicted capacity is outputted to the bit rate control circuit A of the signal processing device P1 shown in FIG. 2, as the bit rate control target.

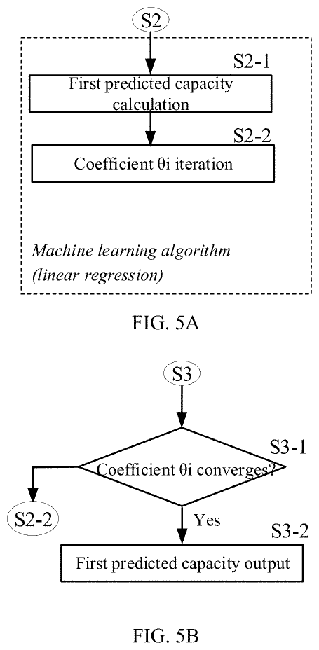

In the following, as an example, a linear regression algorithm of the logistic regression is illustrated as the machine learning algorithm. The channel capacity prediction process and the predicted result output process are illustrated in various embodiments with reference to FIGS. 5A and 5B.

FIG. 5A is a flowchart of a channel capacity prediction process according to an example embodiment of the present disclosure. FIG. 5B is a flowchart of a predicted result output process according to an example embodiment of the present disclosure.

As shown in FIG. 5A, the channel capacity prediction process (S2) includes: calculating the first predicted capacity (S2-1) and performing an iteration process for a coefficient θᵢ (S2-2).

At the first predicted capacity calculation process (S2-1), the first predicted capacity is calculated by the following equation (3)

h=Σᵢ₌₁^{N}θᵢcᵢ=θ^{T}c (3)

where cᵢ represents the historic throughput of the channel corresponding to the i-th preceding frame, i and N are natural numbers greater than or equal to 1, i is smaller than or equal to N, h is an estimated throughput for a succeeding frame, θᵢ is a coefficient for calculating the throughput h for the succeeding frame based on the preceding historic throughput cᵢ, θ^{T} c is a vectorized expression of the previous summation, θ=[θ₁, θ₂, . . . θ_{N}]^{T} is a vector formed by θᵢ, c=[c₁, c₂, . . . , c_{N}]^{T} is a vector formed by cᵢ, and T is a vector transpose symbol.

At the iteration process for the coefficient θᵢ (S2-2), the coefficient θᵢ is calculated by the following iteration equation (3-1)

θⱼ:=θⱼ+μ(c⁽ⁱ⁾−h_{θ}(c⁽ⁱ⁾))c⁽ⁱ⁾ (3-1)

where c⁽ⁱ⁾ represents an actual throughput rate of the channel corresponding to the i-th frame, h_{θ}(c⁽ⁱ⁾) is a historic estimated throughput rate of the channel corresponding to the i-th frame, μ is a learning rate parameter, j is a natural number greater than or equal to 1, j is smaller than or equal to N, θⱼ indicates that all θ0 are updated once till the i-th frame on the time axis, and a relationship between j and i is that when i is N, j is 1, 2, . . . , N.

In addition, the throughput rate refers to an amount of information (e.g., signal stream, data stream) passing through in a unit time, usually in the unit of Mbps (i.e., megabits per second). In the operation of the system, each frame generates an estimated throughput rate within the frame time. At the same time, an actual throughput rate is accurately measured. The former is referred to as the historic estimated throughput rate because it occurs before a time period. The latter is referred to as the actual throughput rate. In addition, the learning rate parameter is a parameter for adjusting a convergence speed of the iteration process. When the parameter is small, the convergence speed is slow. When the parameter is large, the convergence speed is fast, but it is also likely to cause oscillations near an optimal point. In addition, in the iteration equation (3-1), the subscript of θⱼ varies. That is, at the i-th frame on the time axis, all θ are updated once. j indicates that it is different from i. j is between 1 and N.

As shown in FIG. 5B, the predicted result output process (S3) includes: a coefficient determination process (S3-1) and a first predicted capacity output process (S3-2).

At the coefficient determination process (S3-1), whether the coefficient θⱼ obtained by performing the iteration process using the iteration equation (3-1) converges is determined. If it is determined that the coefficient θⱼ converges, the process proceeds to S3-2 for outputting the first predicted capacity. If it is determined that the coefficient θⱼ does not converge, after waiting for a certain time period, the process returns to S2-2 for repeating the iteration process for the coefficient θᵢ. This is because after the initialization or a drastic channel environment change, the convergence of the linear regression algorithm takes time.

At the first predicted capacity output process (S3-2), the h value calculated by equation (3) becomes the first predicted capacity, and the first predicted capacity is outputted as the capacity prediction result. That is, as the bit rate control target, the capacity prediction result is outputted to the bit rate control circuit A of the signal processing device P1 shown in FIG. 2.

In the embodiments of the present disclosure, the machine learning algorithm replaces the window averaging algorithm or linear fitting algorithm to reduce the error between the predicted channel capacity and the actual channel capacity and to track the trend of the channel changes. While ensuring the quality of signal transmission, the disclosed method also reduces the occurrence of frame loss, pausing, and link loss, and improves the user experience.

In addition, when the machine learning, i.e., the linear regression algorithm, is used to predict the channel capacity, the convergence may take some time in presence of the drastic channel environment change. Thus, in terms of instant output, compared with the window averaging algorithm or linear fitting algorithm, the channel capacity prediction method using the machine learning is slightly less favorable.

In this regard, the present disclosure further provides a method combining the advantages of both the window averaging algorithm or linear fitting algorithm and the machine learning algorithm.

The channel capacity prediction method having the combined advantages is similar to the flowchart shown in FIG. 4, but has a different capacity prediction process at S2 and a different prediction result output process at S3.

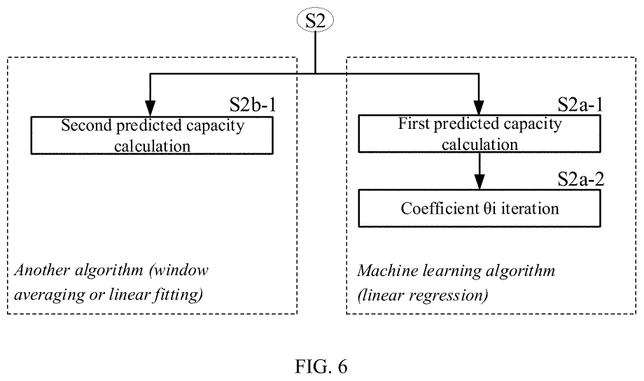

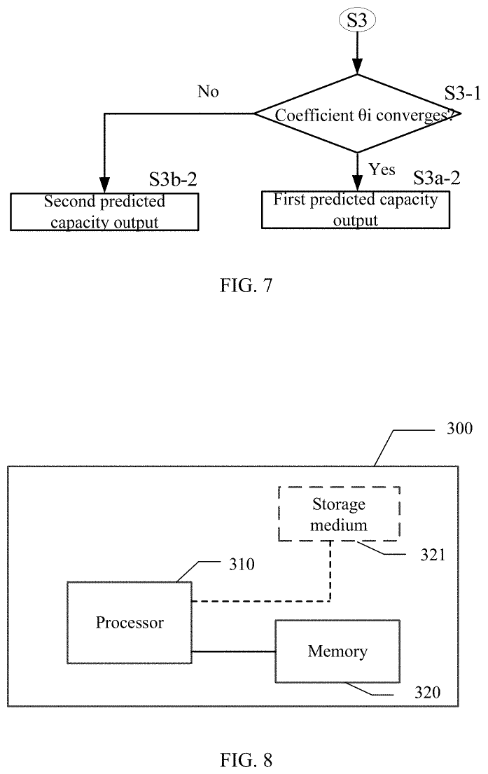

The differences between this method and the previously described methods will be described below with reference to FIG. 6 and FIG. 7.

FIG. 6 is a flowchart of the channel capacity prediction process according to another example embodiment of the present disclosure.

As shown in FIG. 6, at the capacity prediction process (S2), both another algorithm (e.g., the window averaging algorithm or linear fitting algorithm) for calculating the predicted capacity and the machine learning algorithm for calculating the predicted capacity are included.

In some embodiments, the capacity prediction process S2 includes: using the other algorithm (e.g., the window averaging algorithm or linear fitting algorithm) to calculate a second predicted capacity (S2b-1), using the machine learning algorithm to calculate the first predicted capacity (S2a-1), and performing the iteration process for the coefficient θᵢ (S2-2).

At the second predicted capacity calculation process (S2b-1), the window averaging algorithm or the linear fitting algorithm (e.g., the least square fitting straight line algorithm) is used to calculate the second predicted capacity of the channel. In some embodiments, equation (1) or equation (2), equation (2-1), and equation (2-2) may be used to calculate the second predicted capacity of the channel.

At S2a-1, i.e., calculating the first predicted capacity using the machine learning algorithm, the linear regression algorithm is used. In some embodiments, equation (3) is used to calculate the first predicted capacity of the channel. Further, iteration equation (3-1) is used to perform the iteration process for the coefficient θᵢ.

FIG. 7 is a flowchart of the predicted result output process according to another example embodiment of the present disclosure.

As shown in FIG. 7, the predicted result output process S3 includes: a coefficient determination process (S3-1), a first predicted capacity output process (S3a-2), and a second predicted capacity output process (S3b-2).

At the coefficient determination process (S3-1), whether the coefficient θⱼ obtained by performing the iteration process using iteration equation (3-1) converges is determined. If it is determined that the coefficient θⱼ converges, the process proceeds to S3a-2 for outputting the first predicted capacity. If it is determined that the coefficient θⱼ does not converge, the process proceeds to S3b-2 for outputting the second predicted capacity.

At the first predicted capacity output process (S3a-2), the h value calculated by equation (3) becomes the first predicted capacity, and the first predicted capacity is outputted as the capacity prediction result. That is, as the bit rate control target, the capacity prediction result is outputted to the bit rate control circuit A of the signal processing device P1 shown in FIG. 2.

At the second predicted capacity output process (S3b-2), the c_{N+1} value calculated by equation (1) or equation (2) becomes the second predicted capacity, and the second predicted capacity is outputted as the capacity prediction result. That is, as the bit rate control target, the capacity prediction result is outputted to the bit rate control circuit A of the signal processing device P1 shown in FIG. 2.

In the channel capacity prediction method according to the embodiments of the present disclosure, the other algorithm (e.g., the window averaging algorithm or linear fitting algorithm) and the machine learning algorithm are effectively combined. The other algorithm (e.g., the window averaging algorithm or linear fitting algorithm) is the backup algorithm in case the machine learning algorithm does not converge. It takes into account the advantages of the prediction reliability of the machine learning algorithm training model and the instant output of the algorithm.

Therefore, according to the channel capacity prediction method consistent with the embodiments of the present disclosure, the wireless signal sending device and system provide more accurate channel capacity prediction with smaller errors for the wireless signal communication in the long distance data transmission, such as the wireless image transmission system for transmitting image data. While ensuring the quality of signal transmission, the disclosed method also reduces the occurrence of frame loss, pausing, and link loss, and improves the user experience.

In the following, a channel capacity prediction apparatus for implementing the disclosed channel capacity prediction method in a hardware form is illustrated in FIG. 8.

FIG. 8 is a schematic structural diagram of a channel capacity prediction apparatus according to an embodiment of the present disclosure.

As shown in FIG. 8, the channel capacity prediction apparatus 300 includes: a processor 310 (e.g., a CPU) and a memory 320 (e.g., a hard disk drive HDD, a read-only memory ROM, etc.). In addition, the channel capacity prediction apparatus 300 may also include a computer readable storage medium 321 (e.g., a magnetic disk, an optical disk, CD-ROM, a USB drive, etc.) indicated by a dotted line.

In addition, FIG. 8 is only an example, and does not limit the technical solution of the present disclosure. Each part of the channel capacity prediction apparatus 300 may be one or more. For example, the processor 310 may include one or more processors.

In this way, the processes described above with reference to the flowcharts (FIGS. 4-7) of the channel capacity prediction method consistent with the embodiments of the present disclosure may be implemented as a computer software program. The computer software program may include one or more programs.

In some embodiments, the computer software program is stored in the memory 320 of the channel capacity prediction apparatus 300. When being executed, the computer software program causes one or more processors 310 of the channel capacity prediction apparatus 300 to implement the channel capacity prediction method and variations thereof as illustrated in the flowcharts shown in FIGS. 4-7.

Therefore, the wireless signal sending device and system provide more accurate channel capacity prediction with smaller errors for the wireless signal communication in the long distance data transmission, such as the wireless image transmission system for transmitting image data. While ensuring the quality of signal transmission, the disclosed method also reduces the occurrence of frame loss, pausing, and link loss, and improves the user experience.

In addition, the channel capacity prediction method may be implemented by a computer program stored in a computer readable storage medium (e.g., the computer readable storage medium 321 shown in FIG. 8). The computer program may include code/computer executable instruction, and when being executed by a computer, implement the channel capacity prediction method and variations thereof in the flowcharts shown in FIGS. 4-7.

In addition, the computer readable storage medium may include any medium that contains, stores, transmits, broadcasts, or transfers instructions. For example, the computer readable storage medium may include, but I not limited to, electrical, magnetic, optical, electromagnetic, infrared, or semiconductor systems, devices, components, or transmission media. Examples of the computer readable storage medium includes: magnetic storage devices (e.g., magnetic tapes or hard disk drives HDD), optical storage device (e.g., CD-ROM), memories (e.g., random access memories RAM, flash memories), and/or wired/wireless communication links.

In addition, the computer program may be configured to have, for example, computer program codes including computer program modules. It should be noted that partition methods and quantities of the modules are not fixed. Those skilled in the art can determine suitable program modules or combination of program modules according to actual applications. When being executed by a computer (or a processor), the combination of program modules causes the computer to implement the channel capacity prediction method and variations thereof in the flowcharts shown in FIGS. 4-7.

Those skilled in the art understand that the features recited in various embodiments and/or claims of the present disclosure may be combined in various ways, even if such combinations are not explicitly described in the present disclosure. In particular, the features recited in various embodiments and/or claims of the present disclosure may be combined in various ways without departing from the spirit and teaching of the present disclosure. All the combinations should fall within the scope of the present disclosure.

Various embodiments of the present disclosure are used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. The scope of invention should be determined by the appended claims.

What is claimed is:

1. A channel capacity prediction method comprising:
collecting historic data of a channel for transmitting wireless signals to generate statistics information;
obtaining a capacity prediction result based on the statistics information, including calculating a predicted capacity; and
outputting the capacity prediction result.

2. The method of claim 1, wherein the historic data includes at least a historic throughput of the channel.

3. The method of claim 1, wherein the historic data includes at least one of a historic throughput, a historic signal-to-noise ratio, a historic signal intensity, a historic modulation mode, or a historic channel estimation.

4. The method of claim 1, wherein a machine learning algorithm is used to calculate the predicted capacity of the channel based on the statistics information.

5. The method of claim 4, wherein the machine learning algorithm includes a linear regression algorithm.

6. The method of claim 5, wherein:
the historic data includes historic throughputs of the channel corresponding to preceding N frames, and the statistics information includes c₁, c₂, . . . , c_{N};
the predicted capacity is calculated using equation (a):
h=Σᵢ₌₁^{N}θᵢcᵢ (a)
where cᵢ represents the historic throughput of the channel corresponding to an i-th preceding frame, i and N are natural numbers greater than or equal to 1, i is smaller than or equal to N, h is an estimated throughput for a succeeding frame, and θᵢ is a coefficient and is calculated by iteration using equation (a-1):
θⱼ:=θⱼ+μ(c⁽ⁱ⁾−h_{θ}(c⁽ⁱ⁾))c⁽ⁱ⁾ (a-1)
where c⁽ⁱ⁾ represents an actual throughput rate of the channel corresponding to the i-th frame, h_{θ}(c⁽ⁱ⁾) is a historic estimated throughput rate of the channel corresponding to the i-th frame, μ is a learning rate parameter, j is a natural number greater than or equal to 1 and smaller than or equal to N, θⱼ indicates that all ƒ are updated once till the i-th frame on a time axis, and a relationship between j and i is that when i is N, j is 1, 2, . . . , N; and
outputting the predicted capacity includes, in response to determining that the coefficient θᵢ converges, outputting the h value calculated by equation (a) as the predicted capacity.

7. The method of claim 6, wherein:
the predicted capacity is a first predicted capacity;
obtaining the capacity prediction result further includes calculating a second predicted capacity based on the statistics information using a window averaging algorithm or a least square fitting straight line algorithm; and
outputting the prediction result includes, in response to determining that the coefficient θᵢ does not converge, outputting the second predicted capacity as the capacity prediction result.

8. The method of claim 7, wherein:
the second predicted capacity is calculated using the window averaging algorithm according to equation (b):
$${c}_{N + 1} = \frac{1}{N} {Σ}_{i = 1}^{N} {c}_{i} \qquad ( b )$$
where c_{N+1} represents the second predicted capacity.

9. The method of claim 7, wherein:
the second predicted capacity is calculated using the least square fitting straight line algorithm according to equation (c):
c_{N+1}=â×(N+1)+\hat{b} (c)
where â and \hat{b} are obtained according to equation (c-1) and equation (c-2), respectively:
$$\begin{matrix}\hat{a} = \frac{( {Σ}_{1}^{N} {i}^{2} ) ( {Σ}_{1}^{N} {c}_{i} ) - ( {Σ}_{1}^{N} i ) ( {Σ}_{1}^{N} i \times {c}_{i} )}{N ( {Σ}_{1}^{N} {i}^{2} ) - {( {Σ}_{1}^{N} i )}^{2}} & ( c \text{-} 1 ) \\ \hat{b} = \frac{N ( {Σ}_{1}^{N} i \times {c}_{i} ) - ( {Σ}_{1}^{N} i ) ( {Σ}_{1}^{N} {c}_{i} )}{N ( {Σ}_{1}^{N} {i}^{2} ) - {( {Σ}_{1}^{N} i )}^{2}} & ( c \text{-} 2 )\end{matrix}$$
where c_{N+1} represents the second predicted capacity.

10. The method of claim 1, wherein:
the channel is a channel of a wireless transmitter circuit of a wireless image transmission system; and
wireless signals transmitted in the channel are image signals.

11. The method of claim 10, wherein the capacity prediction result is outputted to a bit rate control circuit for controlling a bit rate of the wireless image transmission system.

12. A channel capacity prediction apparatus comprising:
a processor; and
a memory storing computer executable instructions that, when executed by the processor, cause the processor to:
collect historic data of a channel for transmitting wireless signals to generate statistics information;
obtain a capacity prediction result based on the statistics information, including calculating a predicted capacity; and
output the capacity prediction result.

13. The apparatus of claim 12, wherein the historic data includes at least a historic throughput of the channel.

14. The apparatus of claim 12, wherein the historic data of the channel includes at least one of a historic throughput, a historic signal-to-noise ratio, a historic signal intensity, a historic modulation mode, or a historic channel estimation.

15. The apparatus of claim 12, wherein a machine learning algorithm is used to calculate the predicted capacity of the channel based on the statistics information.

16. The apparatus of claim 15, wherein the machine learning algorithm includes a linear regression algorithm.

17. The apparatus of claim 16, wherein:
the historic data includes historic throughputs of the channel corresponding to preceding N frames, and the statistics information includes c₁, c₂, . . . , c_{N};
the predicted capacity is calculated using equation (a):
h=Σᵢ₌₁^{N}θᵢcᵢ (a)
where cᵢ represents the historic throughput of the channel corresponding to an i-th preceding frame, i and N are natural numbers greater than or equal to 1, i is smaller than or equal to N, h is an estimated throughput for a succeeding frame, and θᵢ is a coefficient and is calculated by iteration using equation (a-1):
θⱼ:=θⱼ+μ(c⁽ⁱ⁾−_{θ}(c⁽ⁱ⁾))c⁽ⁱ⁾ (a-1)
where c⁽ⁱ⁾ represents an actual throughput rate of the channel corresponding to the i-th frame, h_{θ}(c⁽ⁱ⁾) is a historic estimated throughput rate of the channel corresponding to the i-th frame, μ is a learning rate parameter, j is a natural number greater than or equal to 1 and smaller than or equal to N, θⱼ indicates that all θ are updated once till the i-th frame on a time axis, and a relationship between j and i is that when i is N, j is 1, 2, . . . , N; and
the instructions further cause the processor to, in response to determining that the coefficient θᵢ converges, output the h value calculated by equation (a) as the predicted capacity.

18. The apparatus of claim 17, wherein:
the predicted capacity is a first predicted capacity; and
the instructions further cause the processor to:
calculate a second predicted capacity based on the statistics information using a window averaging algorithm or a least square fitting straight line algorithm; and
in response to determining that the coefficient θᵢ does not converge, output the second predicted capacity as the capacity prediction result.

19. The apparatus of claim 12, wherein:
the channel is a channel of a wireless transmitter circuit of a wireless image transmission system; and
wireless signals transmitted in the channel are image signals.

20. The apparatus of claim 19, wherein the capacity prediction result is outputted to a bit rate control circuit for controlling a bit rate of the wireless image transmission system.
